(19) United States
(12) Patent Application Publication
(10) Pub. No.: US 2011/0191401 A1
(43) Pub. Date: Aug. 4, 2011

(54) CIRCUIT AND METHOD FOR CHOLESKY BASED DATA PROCESSING

(75) Inventors: Mridul Manohar Mishra, Noida (IN); Priyanka Verma, Noida (IN)

(73) Assignee: FREESCALE SEMICONDUCTOR, INC., Austin, TX (US)

(21) Appl. No.: 12/697,293

(22) Filed: Jan. 31, 2010

(51) Int. Cl. G06F 7/32

(52) U.S. Cl. 708/520

(57) ABSTRACT

A method for Cholesky based processing of data includes receiving a first matrix that equals a product of a first lower triangular matrix and a first upper triangular matrix, where the first upper triangular matrix is a complex conjugate transpose of the first lower triangular matrix, and applying, by a processing unit that has a set of P processors, a loopless Cholesky factorization process on each equally sized block of multiple equally sized blocks of the first matrix to provide the first lower triangular matrix. Each equally sized block has E elements, where E is a integer multiple of P.

### BACKGROUND OF THE INVENTION

The present invention relates to data processing and, more particularly, to a circuit and method for Cholesky decomposition, and forward and backward substitution, which can be used for various purposes such as but not limited to equalization, filtering data, reconstructing data, and the like.

A Hermitian positive definite matrix (also referred to as first matrix) can equal a product of a first lower triangular matrix and a first upper triangular matrix that is a complex conjugate transpose of the first lower triangular matrix. The Cholesky factorization process is applied on a first matrix R to provide the first lower triangular matrix L (R=LL*). It is noted that “*” indicates a conjugate transpose operation, in this case on the matrix L. That is, “L*” is the conjugate transpose of L and LL* is matrix multiplication of L with its own conjugate transpose.

In problems involving matrix inversion, where an unknown vector is calculated from a set of linear equations, Cholesky factorization is usually followed by forward and backward substitution, respectively. For example, a set of linear equations is written as Rx=b where x is an unknown vector and R is factorized into a lower triangular matrix L such that R=LL*. Forward substitution is used to find the unknown vector y in equation set Ly=b and backward substitution is used to find the unknown vector x in equation set L*x=y.

The following pseudo-code illustrates a conventional Cholesky factorization process that has an output L.

for j=1:1:N {for any index j that ranges between 1 and N, at steps of 1}

R(1:j−1, j) = 0; {nullify elements above the diagonal of R}
R(:, j) = R(:, j)/sqrt[R(j, j)];

for i = j+1:1:N

R(i:1:N, i) = R(i:1:N, i) − R(i:1:N, j) x R(i, j)*;

end

end

This conventional Cholesky factorization process requires execution of many loops that slow down the Cholesky factorization process. In addition, this Cholesky factorization process is not well fitted to parallel processing. It would be advantageous to be able to efficiently perform Cholesky factorization of data.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 is a diagram illustrating an example of a first matrix and multiple equally sized blocks in accordance with an embodiment of the present invention;

FIG. 2 is a schematic block diagram of an integrated circuit in accordance with an embodiment of the present invention; and

FIG. 3 is a flow-chart illustrating a method for processing data in accordance with an embodiment of the present invention.

### DETAILED DESCRIPTION OF THE PREFERRED EMBODIMENTS

The illustrated embodiments of the present invention may for the most part, be implemented using electronic components and circuits known to those skilled in the art, therefore details will not be explained in any greater extent than that considered necessary for the understanding and appreciation of the underlying concepts of the present invention and in order not to obfuscate or distract from the teachings of the present invention.

The below described method and device are adapted to execute a loopless Cholesky factorization process. This loopless Cholesky factorization process is modular in the sense that it can be applied on input matrices of different sizes with great ease. The different sizes of matrices may require adding calls to functions that are applied on equally sized blocks of the input matrices. The first matrix is partitioned to equally sized blocks before the Cholesky factorization process begins. In a sense this is a static partition that differs from a dynamic recursive partition. The outcome of the Cholesky factorization process can be processed by a forward substitution process followed by a backward substitution process.

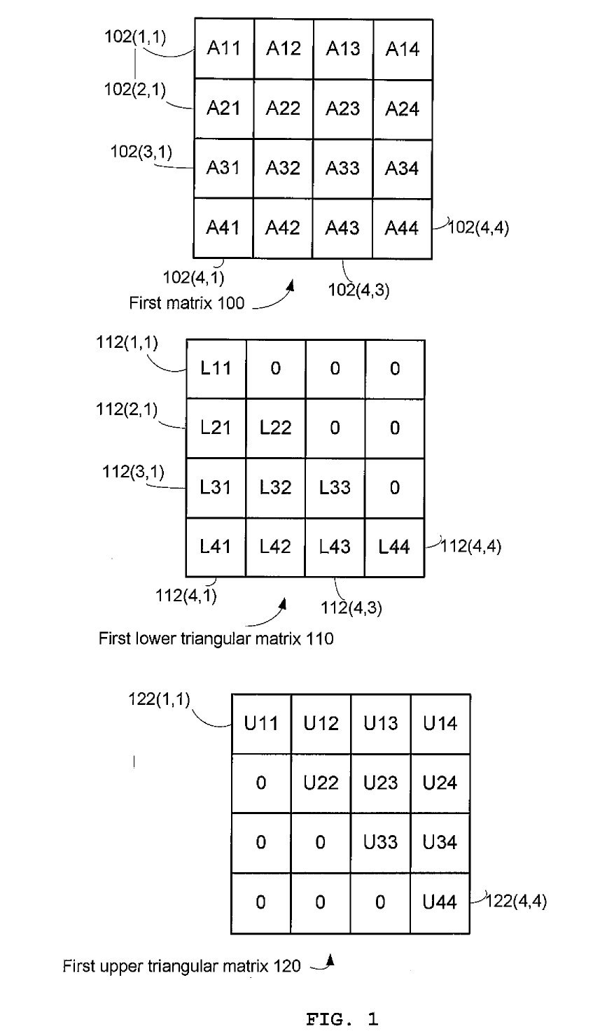

Referring now to FIG. 1, a schematic diagram illustrating an example of a first matrix 100 and multiple equally sized blocks A11-A44 denoted 102 (1, 1)-102 (4, 4), according to an embodiment of the present invention, is shown. The first matrix 100 is a positive definite Hermitian matrix that equals a product of a first lower triangular matrix 110 and a first upper triangular matrix 120 that is a complex conjugate transpose of first lower triangular matrix.

The first lower triangular matrix 110 is illustrated as including equally sized blocks L11-L44 denoted 112 (1, 1)-112 (4, 4). The first upper triangular matrix 120 is illustrated as including equally sized blocks U11-U44 denoted 122 (1, 1)-122 (4, 4). The elements of the first matrix 100 represent a physical entity such as a transfer function of a receiver, a transfer function of a channel over which information is being transmitted, a filter, a noise inducing process, and the like.

Each block 102 (k, k) is a matrix that includes E elements. These E elements are arranged in e columns and e rows. In other words, each block is a matrix that includes E=e×e elements. Index k ranges between 1 and K. Note in FIG. 1, K equals four. The number of rows or columns per block 102 (k, k) can equal the number of processors P of a processing unit used to execute the loopless Cholesky factorization process of the present invention. The number of elements per block can be equal to P̂2.

The processing unit executes the loopless Cholesky factorization process in a parallel manner in the sense that multiple processors of the processing unit can operate in parallel with each other. The number (k) of rows of columns per block 102 (k, k) can be an integer multiple of P (P, 2P, 3P, . . . ). For simplicity of explanation, it is assumed that the first matrix 100 is Cholesky factorized by a processing unit that includes 4 processors (P=4). It is further assumed that the first matrix 100 has sixteen blocks A11-A44 and that each block includes 2×2 elements. However, it should be understood that the first matrix 100 can have more or fewer than sixteen blocks, and that each block 102 (k, k) can have more than 4×4 elements.

The first matrix 100 is partitioned to equally sized blocks 102 (1, 1)-102 (4, 4) in the sense that the loopless Cholesky factorization process operates on a block to block basis. The loopless Cholesky factorization process includes multiple functions, each being provided with one or more blocks and outputs an updated block. Additionally or alternatively, the partitioning of the first matrix 100 can determine the manner in which the different elements of first matrix 100 will be stored in a memory. For example, elements of the same block preferably are grouped together and stored in adjacent entries of a memory.

The loopless Cholesky factorization process is applied on all the equally sized blocks in order to calculate either one of the first lower triangular matrix 110 and the first upper triangular matrix 120 that their product provides the first matrix 100. It is assumed, for simplicity of explanation, that the loopless Cholesky factorization process is applied in order to calculate the first lower triangular matrix 110. In one embodiment of the invention, when the first lower triangular matrix 110 is being computed, the blocks that are above the diagonal of the first matrix 100 are ignored; that is, in practise, during the loopless Cholesky factorization process the blocks above the diagonal of the first matrix 100 are nullified.

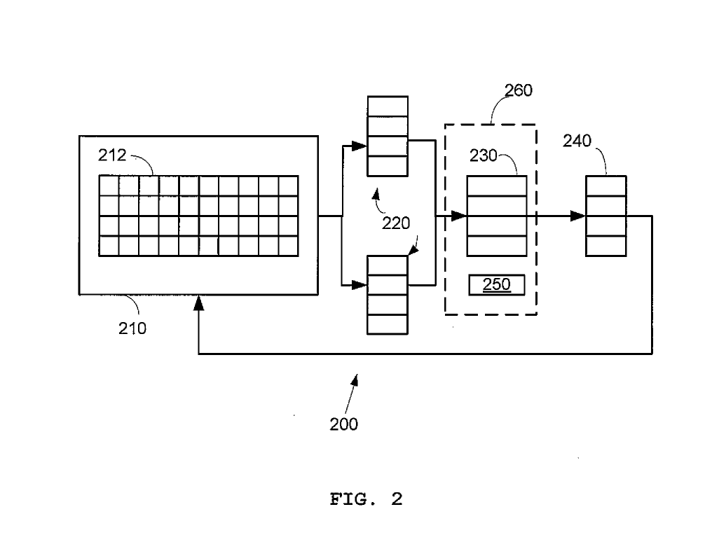

FIG. 2 is a schematic block diagram of an integrated circuit 200 according to an embodiment of the invention. The integrated circuit 200 includes a memory 210, an input register array 220, an output register array 240, and a processing unit 260. The integrated circuit 200 can be included, for example, in a receiver that receives data signals that may have been corrupted while being transmitted over a channel. The channel impulse response can be represented by a first matrix that is Cholesky decomposed during the equalization process.

The processing unit 260 may include a processor array 230 of P processors and may also include a controller 250. The P processors of the processor array 230 preferably operate in parallel with each other. For simplicity of explanation, FIG. 2 illustrates four processors (P=4) but the integrated circuit 200 can include a number P of processors that differs from four.

The memory 210 stores the elements of first matrix 100, intermediate results generated during the loopless Cholesky factorization process, and the elements of the lower triangular matrix 110 that are provided as an output of the loopless Cholesky factorization process. In one embodiment of the invention, the memory 210 also stores a data vector that is processed in order to reconstruct data, intermediate results, and the output of additional processes such as a loopless forward substitution process and a loopless backward substitution process.

The memory 210 preferably stores the elements of the first matrix 100 in an arrayed manner in order to facilitate retrieval of multiple (for example—P) elements of information in parallel to the input register array 220. FIG. 2 illustrates an array of elements that is denoted 212. In one embodiment of the invention, the width of the memory 210 is equal to a multiple integer (Q) of a product of P and a width of an element (of information). Various non-limiting examples of storage schemes are illustrated below. The first example illustrates a low-triangular storage scheme of blocks A11, A21, A31, A41, A32, A33, A42, A43 and A44:

| | | | |
|---|---|---|---|
| A11 | | | |
| A21 | A22 | | |
| A31 | A32 | A33 | |
| A41 | A42 | A43 | A44. |

This low-triangular storage scheme can be used during a block column traversing of the blocks of the first matrix. It is noted that the storage schemes and traversing schemes are independent from each other. The blocks can be stored in the memory 210 in a manner that is left to right, i.e., A11->A21->A22->A31-> . . . ->A44.

For this example, the block column traversing includes the following update sequence:

Normalize A11.

Update A21 by A11.

Update A31 by A11.

Update A41 by A11.

Update A32 by A21 and A31 and update A22 by A21, normalize A22 and A32.

Update A42 by A21 and A4, update A41 by A22 and normalize A42.

Update A31 by A32 and then update A33 by A31 and normalize A33.

Update A43 by A31 and A41, update A43 by A32, update A43 by A42, normalize A43.

Update A44 by A41, update A44 by A42, update A44 by A43 and normalize A44.

A second example shown below illustrates a block column shift upper triangular storage scheme.

| | | | |
|---|---|---|---|
| A11 | A22 | A33 | A44 |
| A21 | A32 | A43 | |
| A31 | A42 | | |
| A41 | | | |

This block column shift upper triangular storage scheme can be used during a block row traversing of the blocks of the first matrix. It is noted that the storage schemes and traversing schemes are independent from each other. The block row traversing may include the following update sequence:

Normalize A11.

Update A21 by A11.

Update A22 by A21 and normalize A22.

Update A31 by A11.

Update A32 by A21 and A31, update and normalize A32 by A22.

Update A33 by A31, update A33 by A32, normalize A33.

Update and normalize A41 by A11.

Update A42 by A21 and A41, update and normalize A42 by A22

Update A43 by A31 and A41, update A43 by A32 and A42, update and normalize A3 by A33.

Update A44 by A41, update A44 by A42, update A44 by A43 and normalize A44.

The block column shift upper triangular storage scheme, when used during block row traversing can be more effective (in comparison to the low-triangular storage scheme used during a block column traversing or other combinations of memory storage and memory traversing schemes) in non-cacheable systems but can be less effective (in comparison to the low-triangular storage scheme used during a block column traversing or other combinations of memory storage and memory traversing schemes) when used in cacheable systems.

A third example illustrates few data elements of the first matrix 100 that is stored in the memory 210 in a low-triangular storage scheme, after the elements of the first matrix 100 that were above the diagonal of the first matrix 100 were nullified (assuming memory addresses are incrementing from right to left).

| | | | | | | | | | | | |
|---|---|---|---|---|---|---|---|---|---|---|---|
| 0 | 0 | 0 | a55 | a54 | a53 | a52 | a51 | 0 | 0 | 0 | a11 |
| 0 | 0 | a66 | a65 | a64 | a63 | a62 | a61 | 0 | 0 | a22 | a21 |
| 0 | a77 | a76 | a75 | a74 | a73 | a72 | a71 | 0 | a33 | a23 | a31 |
| a88 | a87 | a86 | a85 | a84 | a83 | a82 | a81 | a44 | a43 | a24 | a41 |

The elements a11-a44 belong to the block A11, the elements a51-a54, a61-a64, a71-a74 and a81-84 belong to the block A21, and the other elements belong to the block A22. Preferably, the four elements of each column are sent in parallel to the input register array 220. For example, during a first retrieval cycle, the elements a11, a21, a31 and a41 are sent to the input buffer array 220. During a second retrieval cycle, the elements 0, a22, a32 and a42 are sent to the input buffer array 220.

Referring again to FIG. 2, the input register array 220 is illustrated as including eight registers. These eight registers can provide two sets of elements in parallel to the processor array 230. This arrangement can be beneficial when each processor requires up to two elements in each computational cycle. If more than two elements are required, then more than eight registers can be used. Additionally or alternatively, a fast retrieval process that can retrieve more than a single element per input buffer per cycle can be implemented.

The processor array 230 is connected between the input register array 220 and the output register array 240. The processor array 230 can compute up to four processing operations in parallel in order to provide four processed elements (four intermediate results) per computational cycle. The processor array 230 outputs processed elements to the output register array 240. These processed elements can be sent back to the memory 210.

The controller 250 is connected to the memory 210, the input register array 220, the processor array 230 and the output register array 240 and is used to control their operations. The controller 250 can, for example, instruct the input register array 220 to receive a new element, instruct the output register array 240 to output a stored element, control the retrieval of data elements from the memory 210, control the writing of elements to the memory 210 and activate the processor array 230.

The integrated circuit 200 and more particularly the processing unit 260 executes code that applies a loopless Cholesky factorization process as well as forward and backward substitution on each equally sized block of the first matrix 100 to generate the first lower triangular matrix 110. The execution of the loopless Cholesky factorization process includes executing, by the integrated circuit 200, multiple P-element instructions. Each P-element instruction causes the processing unit 260 to calculate in parallel P intermediate results of the loopless Cholesky factorization process. It is noted that the method can be executed by Single Instruction-Multiple Data (SIMD) type systems as well as Multiple Instruction-Multiple Data (MIMD) systems.

Referring to the example set forth in FIG. 2, the integrated circuit 200 executes multiple 4-element instructions, each causing the four processors of the processor array 230 to calculate four intermediate results per computational cycle. The following pseudo-code illustrates a loopless Cholesky factorization process. The loopless Cholesky factorization process includes a sequence of functions explained in greater detail below. Each function receives as input at least one block 102 (k, k).

The pseudo-code is applied on the first matrix 100 that is partitioned to 4×4 blocks (denoted A11-A44) and stored in the memory 210 according to a low-triangular storage scheme. The pseudo-code performs a block column traversing and includes:

AF=A11; AD=A11; Call Update_and_Normalize;

AF=A11; AD=A21; Call Update_and_Normalize;

AF=A11; AD=A31; Call Update_and_Normalize;

AF=A11; AD=A41; Call Update_and_Normalize;

AF=A21; AS=A21; AD=A22; Call Cross_Update;

AF=A22; AD=A22; Call Update_and_Normalize;

AF=A21; AS=A31; AD=A32; Call Cross_Update;

AF=A22; AD=A32; Call Update_and_Normalize;

AF=A21; AS=A41; AD=A42; Call Cross_Update;

AF=A22; AD=A42; Call Update_and_Normalize;

AF=A31; AS=A31; AD=A33; Call Cross_Update;

AF=A32; AS=A32; AD=A33; Call Cross_Update;

AF=A33; AD=A33; Call Update_and_Normalize;

AF=A31; AS=A41; AD=A43; Call Cross_Update;

AF=A32; AS=A42; AD=A43; Call Cross_Update;

AF=A33; AD=A43; Call Update_and_Normalize;

AF=A41; AS=A41; AD=A44; Call Cross_Update;

AF=A42; AS=A42; AD=A44; Call Cross_Update;

AF=A43; AS=A43; AD=A44; Call Cross_Update;

AF=A44; AD=A44; Call Update_and_Normalize;

The Cross_Update function has the following format:

Cross_Update: (AF, AS, AD)

AD_1=AD_1-AF11*AS_1;

AD_2=AD_2-AF21*AS_1;

AD_3=AD_3-AF31*AS_1;

AD_4=AD_4-AF41*AS_1;

AD_1=AD_1-AF12*AS_2;

AD_2=AD_2-AF22*AS_2;

AD_3=AD_3-AF32*AS_2;

AD_4=AD_4-AF42*AS_2;

AD_1=AD_1-AF13*AS_3;

AD_2=AD_2-AF23*AS_3;

AD_3=AD_3-AF33*AS_3;

AD_4=AD_4-AF43*AS_3;

AD_1=AD_1-AF14*AS_4;

AD_2=AD_2-AF24*AS_4;

AD_3=AD_3-AF34*AS_4;

AD_4=AD_4-AF44*AS_4;

Return.

Each line of the Cross-Update function includes a 4-element instruction that once executed by the four processors of the processor array 230 causes the integrated circuit 200 to calculate four different processed elements. For example, the line AD_1=AD_1-AF11*AS_1 represents a four-element instruction that includes the following operations:

AD11=AD11-AF11*AS11;

AD21=AD21-AF11*AS21;

AD31=AD31-AF11*AS31;

AD41=AD41-AF11*AS41.

It is noted that each of these operations (of the four-element instruction) operates on single data elements. If, for example, AD=A11 then AD11 is a11. The Update_and_Normalize function has the following format:

Update_and_Normalize: (AF, AD)

AD_1=AD_1/sqrt(AF11);

AD_2=AD_2-AF21*AD_1;

AD_3=AD_3-AF31*AD_1;

AD_4=AD_4-AF41*AD_1;

AD_2=AD_2/sqrt(AF22);

AD_3=AD_3-AF32*AD_2;

AD_4=AD_4-AF42*AD_2;

AD_3=AD_3/sqrt(AF33);

AD_4=AD_4-AF43*AD_3;

AD_4=AD_4/sqrt(AF44);

Return.

The “sqrt” is a square root operation. Each line of the Cross_Update function includes a 4-element instruction that once executed by the four processors of the processor array 230 causes the integrated circuit 200 to calculate four different processed elements.

The Self_Update function has the following format:

Self_Update: (AD)

AD_1=AD_1/sqrt(AD11);

AD_2=AD_2-AF21*AD_1;

AD_3=AD_3-AF31*AD_1;

AD_4=AD_4-AF41*AD_1;

AD_2=AD_2/sqrt(AD_22);

AD_3=AD_3-AF32*AD_2;

AD_4=AD_4-AF42*AD_2;

AD_3=AD_3/sqrt(AD_33);

AD_4=AD_4-AF43*AD_3;

AD_4=AD_4/sqrt(AD_44);

Return.

Each line of the Self_Update function includes a 4-element instruction that once executed by the four processors of the processor array 230 causes the integrated circuit 200 to calculate four different processed elements.

The loopless Cholesky factorization process is followed by loopless forward and backward substitution processes. The following example assumes that the input vector x may be found by solving y=R*x, where x and y are vectors and R is a matrix. It is also assumed that R is the first matrix 100, L is the lower triangular matrix 110 such that R=L*L and that z is an input data vector. Then the unknown input vector y can be written as y=(LL*)x or y=L(L*x) (As previously noted, * indicates the conjugate transpose of a preceding matrix, so y=(LL*)x means matrix multiplication of L with its own conjugate transpose L*, further multiplied by x). Unknown x is calculated in two steps. Lets call unknown vector (L*x) to be z. Then first solving y=Lz for unknown z and then solving z=L*x for unknown x can obtain x. Solving y=Lz for z is called forward substitution and solving z=Lx for x is called backward substitution. The loopless forward substitution process to solve y=Lz is explained below.

Assuming that the lower triangular matrix has 16 equally sized blocks (L11-L44), each includes 2×2 elements, then this equation can be represented by:

$$( \begin{matrix}L 11 & 0 & 0 & 0 \\ L 21 & L 22 & 0 & 0 \\ L 31 & L 32 & L 33 & 0 \\ L 41 & L 42 & L 43 & L 44\end{matrix} ) X ( \begin{matrix}Z 1 \\ Z 2 \\ Z 3 \\ Z 4\end{matrix} ) = ( \begin{matrix}Y 1 \\ Y 2 \\ Y 3 \\ Y 4\end{matrix} )$$

Each of Z1, Z2, Z3, Z4, Y1, Y2, Y3, and Y4 includes four elements. The following pseudo code illustrates a loopless forward substitution process.

Lr=L11; Zr=Z1; Yr=Y1; call Fwd_Sub;

Lr=L21; Zr=Z1; Yr=Y2; call Update_to_Truncate;

Lr=L22; Zr=Z2; Yr=Y2; call Fwd_Sub;

Lr=L31; Zr=Z1; Yr=Y3; call Update_to_Truncate;

Lr=L32; Zr=Z2; Yr=Y3; call Update_to_Truncate;

Lr=L33; Zr=Z3; Yr=Y3; call Fwd_Sub;

Lr=L41; Zr=Z1; Yr=Y4; call Update_to_Truncate;

Lr=L42; Zr=Z2; Yr=Y4; call Update_to_Truncate;

Lr=L43; Zr=Z3; Yr=Y4; call Update_to_Truncate;

Lr=L44; Zr=Z4; Yr=Y4; call Fwd_Sub.

The Update_to_Truncate function has the following format:

Update_to_Truncate: (Lr, Zr, Yr)

Yr=Yr-Lr_1*Zr1;

Yr=Yr-Lr_2*Zr2;

Yr=Yr-Lr_3*Zr3;

Yr=Yr-Lr4*Zr4;

Return.

Each line of the Update_to_Truncate function includes a 4-element instruction that once executed by the four processors of the processor array 230 causes the integrated circuit 200 to calculate four different processed elements. For example, the line Yr=Yr-Lr1*Zr1 implies:

Yr1=Yr1-Lr11*Zr1;

Yr2=Yr2-Lr21*Zr1;

Yr3=Yr3-Lr31*Zr1;

Yr4=Yr4-Lr41*Zr1;

The forward substitution function has the following format:

Fwd_Sub: (Lr, Zr, Yr) Zr=Yr-Lr_2*Zr2;

Zr=Yr-Lr_3*Zr3;

Zr=Yr-Lr_4*Zr4;

Zr1=Zr1/Lr11;

Zr1=Zr2/Lr22;

Zr1=Zr3/Lr33;

Zr1=Zr4/Lr44;

Return.

Each line of the Fwd_Sub function includes a 4-element instruction that once executed by the four processors of the processor array 230 causes the integrated circuit 200 to calculate four different processed elements. For example, the line Zr=Yr-Lr_2*Zr2 includes the following instructions:

Zr1=Yr1-Lr12*Zr2;

Zr2=Yr2-Lr22*Zr2;

Zr3=Yr3-Lr32*Zr2;

Zr4=Yr4-Lr42*Zr2;

Here Lr is such that Lr12=0. Similarly for second and third equation in the left side box: Lr13=0; Lr23=0; Lr14=0; Lr24=0; Lr34=0. The outcome of the forward substitution can be subjected to a backward substitution process that solves z=L*x to provide an estimated data vector x. Those skilled in art will appreciate that a loopless process for backward substitution can be similar to the forward substitution.

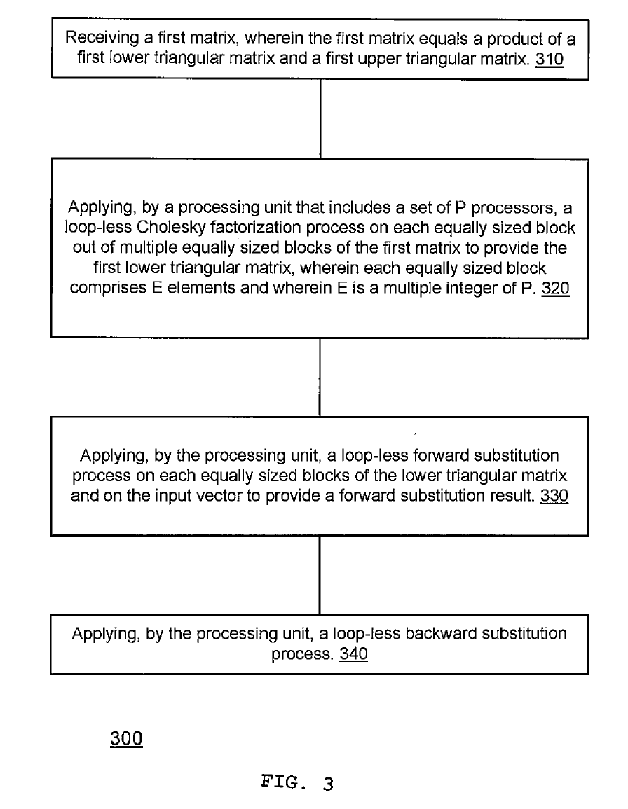

FIG. 3 is a flow chart illustrating a method 300 for processing data in accordance with an embodiment of the present invention. The method 300 starts at step 310, receiving a first matrix, where the first matrix equals a product of a first lower triangular matrix and a first upper triangular matrix that is a complex conjugate transpose of the first lower triangular matrix. Step 310 also includes receiving an input vector.

Step 310 is followed by step 320, applying, via a processing unit that includes a set of P processors, a loopless Cholesky factorization process on each equally sized block out of multiple equally sized blocks of the first matrix to provide the first lower triangular matrix, where each equally sized block comprises E elements, where E is an integer multiple of P. Step 320 can include at least one of the following operations or a combination thereof:

(i) Executing a loopless Cholesky factorization process that includes a sequence of functions, each function receives as input at least one equally sized block.

(ii) Executing a loopless Cholesky factorization process that includes a sequence of functions, each function receives as input at least one equally sized block, wherein each function comprises multiple P-element instructions, wherein each P-element instruction causes the processing unit to calculate in parallel P intermediate results of the loopless Cholesky factorization process.

(iii) Applying of the loopless Cholesky factorization process while traversing the equally sized blocks in a block-column manner.

(iv) Applying of the loopless Cholesky factorization process while traversing the equally sized blocks in a block-row manner.

Step 320 is followed by step 330, which is applying, by the processing unit, a loopless forward substitution process on each equally sized blocks of the lower triangular matrix and on the input vector to provide a forward substitution result. Step 330 can include at least one of the following operations or a combination thereof:

(i) Applying a loopless forward substitution process that includes a sequence of functions, each function receives as input at least one equally sized block blocks of the lower triangular matrix.

(ii) Applying a loopless forward substitution process that includes a sequence of functions, each function receives as input at least one equally sized block of the lower triangular matrix, wherein each function comprises multiple P-element instructions, wherein each P-element instruction causes the processing unit to calculate in parallel P intermediate results of the loopless forward substitution process.

Step 330 is followed by stage 340, which is applying, by the processing unit, a loopless backward substitution process. Step 340 includes at least one of the following operations or a combination thereof:

(i) Applying a loopless backward substitution process that includes a sequence of functions, each function receives as input at least one equally sized block blocks of the lower triangular matrix.

(ii) Applying a loopless backward substitution process that includes a sequence of functions, each function receives as input at least one equally sized block of the lower triangular matrix, wherein each function comprises multiple P-element instructions, wherein each P-element instruction causes the processing unit to calculate in parallel P intermediate results of the loopless backward substitution process.

As previously mentioned, the present invention is useful for equalization of a received signal. In one embodiment, the invention was implemented in software designed to run on a SIMD circuit. Equalization is the process of estimating a transmitted signal from the received signal, which itself is a deteriorated copy of a transmitted signal corrupted by noise in a channel. For proper estimation of the transmitted signal, it is necessary to know the nature of the channel in terms of delay introduced and complex amplitudes. Determining the nature of the channel is called channel estimation. In channel estimation there are “n” linear equations to solve for “n” unknowns, where “n” is the number of channel taps, which itself can be variable, thus “n” may be unknown. The “n” equations if written in the form of vector algebra, come out to be of the y=Ax type where x is unknown and the size of A is “n by n”. Thus, x can be calculated as A⁻¹y (inverted matrix A multiplied by vector y). At this point, the Cholesky algorithm along with forward and backward substitution is used to calculate A⁻¹y. This application of the present invention provides an approach to efficiently implement Cholesky decomposition, and forward and backward substitution on a SIMD system in a modular way such that it is unnecessary to write separate code (software) for different matrix sizes.

In terms of overall input and output of the SIMD circuit, the input is the noise corrupted signal and the output is an estimate of the transmitted signal. But for the Cholesky part of the equalization, it is vector y and matrix A that are input and vector x which is output. Here, the problem of matrix inversion is encountered only during channel estimation. However, there can be many more scenarios where a matrix inversion is required. The present invention can be applied to all such scenarios in conjunction with a SIMD circuit.

In the foregoing specification, the invention has been described with reference to specific examples of embodiments of the invention. It will, however, be evident that various modifications and changes may be made therein without departing from the broader spirit and scope of the invention as set forth in the appended claims. Those skilled in the art will recognize that the boundaries between logic blocks are merely illustrative and that alternative embodiments may merge logic blocks or circuit elements or impose an alternate decomposition of functionality upon various logic blocks or circuit elements. Further, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Those skilled in the art also will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, the examples, or portions thereof, may be implemented as software or code representations of physical circuitry or of logical representations convertible into physical circuitry, such as in a hardware description language of any appropriate type.

The present invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’. However, other modifications, variations and alternatives are also possible. The specifications and drawings are, accordingly, to be regarded in an illustrative rather than in a restrictive sense.

In the claims, the word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. Finally, the mere fact that certain measures are recited in mutually different claims does not indicate that a combination of these measures cannot be used to advantage.

1. A circuit for Cholesky based data processing, the circuit comprising:
a memory for storing a first matrix that equals a product of a first lower triangular matrix and a first upper triangular matrix, wherein the first upper triangular matrix is a complex conjugate transpose of the first lower triangular matrix, and wherein the first matrix includes a plurality of equally sized blocks comprising E elements; and
a processing unit, coupled to the memory, that includes a set of P processors and applies a loopless Cholesky factorization process on each of the equally sized blocks of the first matrix to generate the first lower triangular matrix, and wherein E is an integer multiple of P.

2. The Cholesky based data processing circuit of claim 1, wherein the processing unit is arranged to execute multiple P-element instructions during the applying of the loopless Cholesky factorization process, wherein each P-element instruction causes the processing unit to calculate in parallel P intermediate results of the loopless Cholesky factorization process.

3. The Cholesky based data processing circuit of claim 1, wherein the processing unit is arranged to execute a sequence of functions, each function receiving as input at least one equally sized block.

4. The Cholesky based data processing circuit of claim 3, wherein each function comprises multiple P-element instructions, wherein each P-element instruction causes the processing unit to calculate in parallel P intermediate results of the loopless Cholesky factorization process.

5. The Cholesky based data processing circuit of 1, wherein the processing unit is arranged to apply a loopless forward substitution process on each equally sized block of the lower triangular matrix to provide a forward substitution result.

6. The Cholesky based data processing circuit of claim 5, wherein the processing unit is arranged to execute the loopless forward substitution process by executing a sequence of functions, each function receiving as input at least one equally sized block of the lower triangular matrix.

7. The Cholesky based data processing circuit of claim 6, wherein each function comprises multiple P-element instructions, and each P-element instruction causes the processing unit to calculate in parallel P intermediate results of the loopless forward substitution process.

8. The Cholesky based data processing circuit of claim 5, wherein the processing unit is arranged apply a loopless backward substitution process to provide a backward substitution result.

9. The Cholesky based data processing circuit of claim 1, wherein the data processing circuit receives an input vector and the set of P processors apply a loopless backward substitution process on the input vector and on each equally sized block of the lower triangular matrix to provide a backward substitution result.

10. The Cholesky based data processing circuit of claim 9, wherein the set of P processors is arranged to perform a sequence of functions, each function receiving as input at least one equally sized block of the lower triangular matrix, wherein each function comprises multiple P-element instructions, and wherein each P-element instruction causes the processing unit to calculate in parallel P intermediate results of the loopless backward substitution process.

11. The Cholesky based data processing circuit of claim 10, wherein the set of P processors is arranged to apply a loopless forward substitution process to generate a forward substitution result.

12. The Cholesky based data processing circuit of claim 1, further comprising:
an input register array connected to the memory, the input register array for receiving input data and buffering data being written to the memory; and
an output register array connected to the memory, the output register array for buffering data read from the memory.

13. A method of estimating a transmitted signal transmitted over a channel wherein the transmitted signal is corrupted by channel noise, the method comprising:
receiving a signal transmitted over a channel; and
equalizing the received signal to generate an estimate of the transmitted signal, wherein a loopless Cholesky factorization process is used to solve “n” linear equations where “n” represents a number of taps of the channel, and wherein the loopless Cholesky factorization process includes:
receiving a first matrix, wherein the first matrix equals a product of a first lower triangular matrix and a first upper triangular matrix that is a complex conjugate transpose of the first lower triangular matrix; and
applying, by a processing unit that comprises a set of P processors, the loopless Cholesky factorization process on each equally sized block out of multiple equally sized blocks of the first matrix to provide the first lower triangular matrix, wherein each equally sized block comprises E elements and wherein E is a multiple integer of P, and P represents the number of processors.

14. The method of estimating a transmitted signal of claim 13, further comprising executing multiple P-element instructions during the applying of the loopless Cholesky factorization process, wherein each P-element instruction causes the processing unit to calculate in parallel P intermediate results of the loopless Cholesky factorization process.

15. The method of estimating a transmitted signal of claim 13, wherein the loopless Cholesky factorization process comprises a sequence of functions, each function receiving as an input at least one of the equally sized blocks, and each function comprises multiple P-element instructions, wherein each P-element instruction causes the processing unit to calculate in parallel P intermediate results of the loopless Cholesky factorization process.

16. The method of estimating a transmitted signal of claim 13, further comprising receiving an input vector and applying, by the set of P processors, a loopless forward substitution process on the input vector and on each of the equally sized blocks of the lower triangular matrix to provide a forward substitution result.

17. The method of estimating a transmitted signal of claim 16, further comprising applying a loopless backward substitution process to provide a backward substitution result.

18. The method of estimating a transmitted signal of claim 13, further comprising receiving an input vector and applying, by the set of P processors, a loopless backward substitution process on the input vector and on each of the equally sized blocks of the lower triangular matrix to provide a backward substitution result.

19. The method of estimating a transmitted signal of claim 18, wherein the loopless backward substitution process comprises a sequence of functions, wherein each function receives as an input at least one of the equally sized blocks of the lower triangular matrix, and wherein each function comprises multiple P-element instructions, wherein each P-element instruction causes the processing unit to calculate in parallel P intermediate results of the loopless backward substitution process.

20. The method of estimating a transmitted signal of claim 19, further comprising applying a loopless forward substitution process to provide a forward substitution result.
